(19) United States
(12) Patent Application Publication
(10) Pub. No.: US 2014/0040279 A1
(43) Pub. Date: Feb. 6, 2014

(54) AUTOMATED DATA EXPLORATION

(71) Applicants: Alina Beygelzimer, Ossining, NY (US); Nicholas Mastronarde, Los Angeles, CA (US); Srinivasan Parthasarathy, Yorktown Heights, NY (US); Anton V. Riabov, Yorktown Heights, NY (US); Deepak Turaga, Yorktown Heights, NY (US); Octavian Udrea, Yorktown Heights, NY (US)

(72) Inventors: Alina Beygelzimer, Ossining, NY (US); Nicholas Mastronarde, Los Angeles, CA (US); Srinivasan Parthasarathy, Yorktown Heights, NY (US); Anton V. Riabov, Yorktown Heights, NY (US); Deepak Turaga, Yorktown Heights, NY (US); Octavian Udrea, Yorktown Heights, NY (US)

(73) Assignee: International Business Machines Corporation, Armonk, NY (US)

(21) Appl. No.: 13/565,257

(22) Filed: Aug. 2, 2012

(51) Int. Cl. G06F 17/30

(52) U.S. Cl. 707/748; 707/736; 707/E17.032

(57) ABSTRACT

A method for automated data exploration including selecting a plurality of analytic flows from an analytic flow pattern, executing a task, wherein the task is tracked by the plurality of analytic flows, receiving feedback for each of the plurality of analytic flows, determining a performance score for each of the plurality of analytic flows, and adjusting the flow according to the performance score.

### BACKGROUND

1. Technical Field

The present disclosure generally relates to data mining, machine learning, and data exploration, and more particularly to selecting and deploying analytic flows for data analysis.

2. Discussion of Related Art

Data mining and machine learning are disciplines that involve the development of tools for discovering evolving patterns and behaviors from empirical data and supporting decision based on the patterns and behaviors.

Using a specific mining or learning method on certain data typically involves consuming data sources according to a given data representation, extracting a subset of features of interest from the data, ingesting the features into the learning method to build a model, and evolving or improving the model based on feedback or ground truth. These methods rely on a user's expertise. Typically the user is integrated across the method, and in particular, in the selection of the learning method and in the selection of features of interest. The selection of specific machine learning method(s) for the data exploration is a time consuming and human intensive process requiring expertise in machine learning and the domain of the empirical data.

### BRIEF SUMMARY

According to an embodiment of the present disclosure, a method for automated data exploration includes selecting a plurality of analytic flows from an analytic flow pattern, executing a task, wherein the task is tracked by the plurality of analytic flows, receiving feedback for each of the plurality of analytic flows, determining a performance score for each of the plurality of analytic flows, and adjusting the flow according to the performance score.

According to an embodiment of the present disclosure, a method for automated data exploration includes selecting a plurality of analytic flows from an analytic flow pattern for detecting an anomaly in computer network traffic, executing a task for detecting the anomaly in the computer network traffic, wherein the task is tracked by the plurality of analytic flows, receiving feedback for each of the plurality of analytic flows, determining a performance score for each of the plurality of analytic flows indicative of a respective analytic flow's ability to detect malware activity in the computer network traffic, and adjusting the flow according to the performance score.

### BRIEF DESCRIPTION OF THE SEVERAL VIEWS OF THE DRAWINGS

Preferred embodiments of the present disclosure will be described below in more detail, with reference to the accompanying drawings:

FIG. 1 is an analytic flow pattern according to an embodiment of the present disclosure;

FIG. 2 is an exemplary analytic flow based on the analytic flow pattern of FIG. 1 according to an embodiment of the present disclosure;

FIG. 3 is an illustration of an end-to-end application for performing a machine learning task according to an embodiment of the present disclosure; and

FIG. 4 is a diagram of a computer system for implementing a method for automated data exploration according to an embodiment of the present disclosure.

### DETAILED DESCRIPTION

According to an embodiment of the present disclosure, a machine-learning task may leverage an analytic flow of an application and a corresponding analytic flow pattern for various tasks. These tasks include, but are not limited to, automatic selection of a learning method(s), derivation of features from raw data, selection of features which are input to each method, and adaptation of methods, features, models, and variable parameters involved in these based on feedback.

In many domains, a set of flows for end-users (e.g., domain experts) may follow certain patterns. Flow developers can specify independent flows and patterns of flows. A flow pattern describes a space of possible flows that are structurally similar and perform similar tasks.

Exemplary embodiments of the present disclosure will be described in terms of a security analytics application for computer networks. It should be understood that embodiments described here are merely exemplary, and that various other changes and modifications may be made therein by one skilled in the art without departing from the scope of the present disclosure.

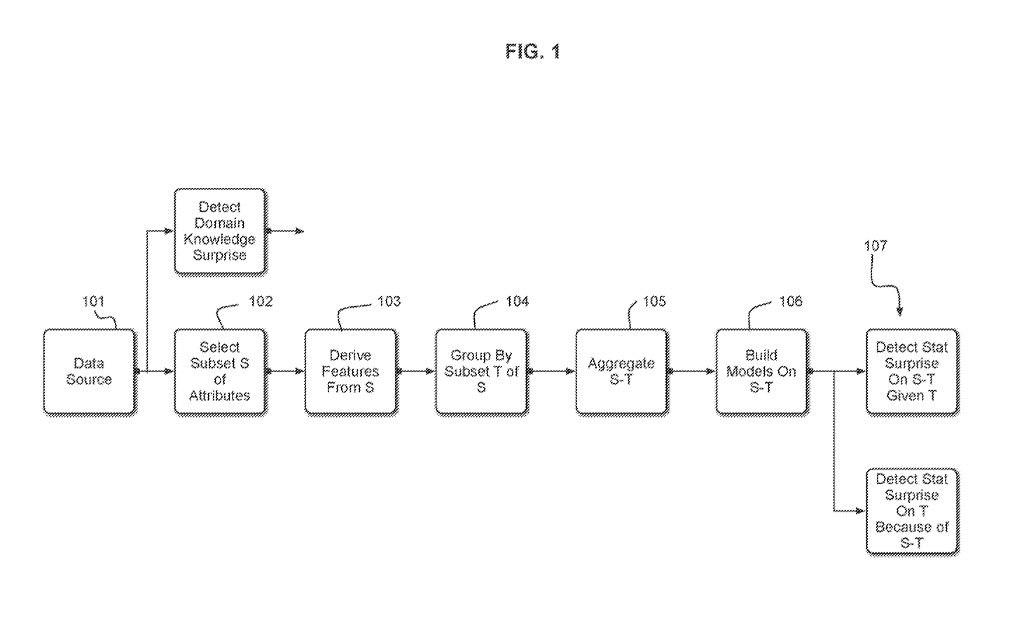

FIG. 1 is an exemplary analytic flow pattern of a security analytics application for computer networks according to an embodiment of the present disclosure. The analytic flow pattern of FIG. 1 is a generic template or a pattern that generalizes and encodes distinct analytic flows among a set of tasks. The analytic flow pattern may be specified by a domain expert, derived from one or more sensors or probes (e.g., outputting events, live data, data logs), etc.

The analytic flow pattern tracks a data stream between the tasks. For example, the analytic flow pattern of FIG. 1 includes ingesting a data source (101), attribute selection (102), feature extraction from selected attributes (103), grouping of the attributes (104) (e.g., according to the extracted features), aggregation of data (105), statistical model building (106), and detection of statistical surprises (107), for example, intrusion detection in the case of the computer network security application.

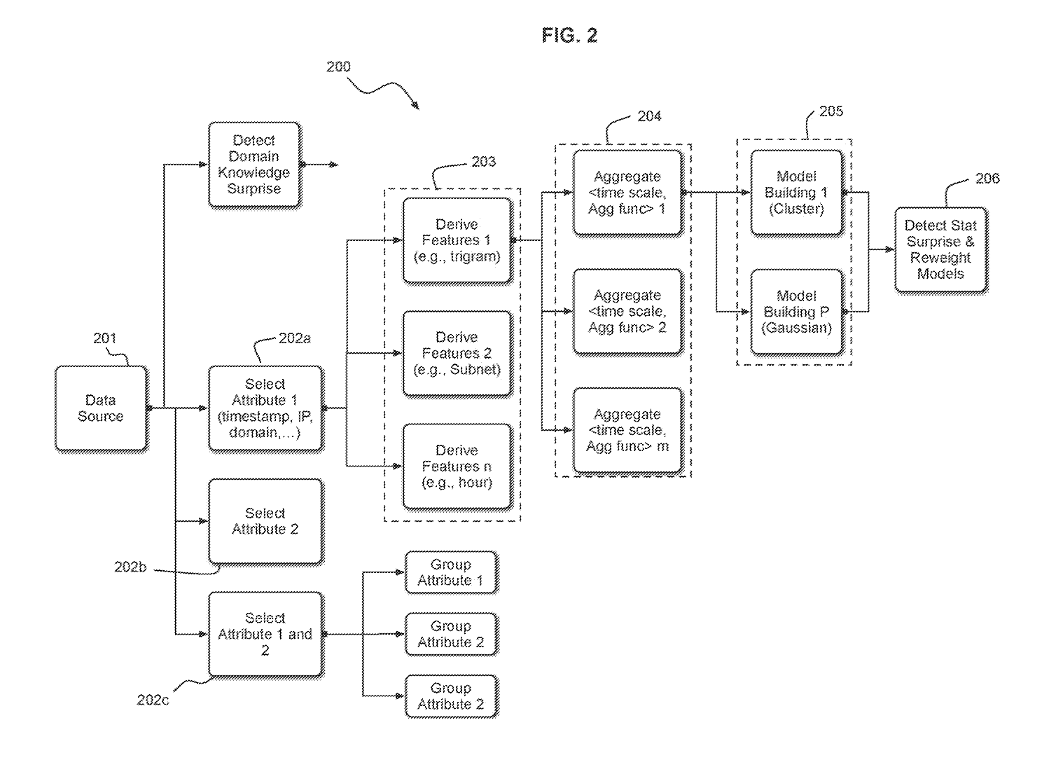

FIG. 2 is an exemplary analytic flow according to an embodiment of the present disclosure, which ingests a domain name server (DNS) data stream. The analytic flow shown in FIG. 2 is an instance of the analytic flow pattern of FIG. 1.

An analytic flow may be extracted from an analytic flow pattern via an analytic ontology, reasoning, automated flow composition/planning methods, etc. For example, in an exemplary automated planning and analytic flow generation tool such as MARIO, the tool uses a repository of annotated analytic flow building blocks (e.g., tagged components), takes in the analytic flow pattern, and automatically creates one or more analytic flows out of the building blocks. More particularly, MARIO is a cross-platform flow composer, which may be used to compose and deploy applications across multiple information processing platforms. MARIO generates high-level platform-independent flows, and invokes platform-specific back-end plug-ins to generate and deploy platform-specific implementations of these flows. The analytic flows are instances of the analytic flow pattern.

The analytic flow pattern may be written in a special purpose language, such as Cascade. Cascade is the language for describing graph patterns. Patterns offer a top-down, structured approach to defining allowable flows. In this way, patterns help restrict a search space of the planner to a smaller set of useful flows. Patterns may also help capture reusable design patterns for information processing in a certain domain.

Different platforms may have their own flow languages, e.g. BPEL for service-oriented systems, SPL used in IBM's System S Stream Processing Platform, Pig Latin used in Apache Pig, etc. Cascade is platform and domain independent. It allows components to be described recursively, where a component is either a primitive component or a composite component, which internally defines a flow of components. Cascade components may be annotated to developers by associating a set of tags with each output port in the analytic flow pattern.

The analytic flow of FIG. 2 represents a specific composition of a data source (201) and various atomic operators (200). The atomic operators (200) represent discrete processes for data exploration and processing. The atomic operators may be considered as containers that host operators implementing data stream analytics. The atomic operators may be distributed on one or more computer nodes. Atomic operators may include analytic operators, data transformations, filters, statistical model builders, etc.

Referring more particularly to FIG. 2, in an analytic flow that ingests a specific data stream, e.g., DNS queries made by users in a network, a first atomic operator (201) ingests the DNS data stream into an analysis pipeline comprising the atomic operators (200). The data stream may have a specific schema. Further, not all attributes in the schema may be useful to a current instance.

Once ingested, attributes of interest may be extracted from the DNS data stream. For example, an atomic operator may be used to extract attributes from the DNS queries and response fields. In FIG. 2 attribute extraction may be performed by a set of atomic operators (202a-202c). For example, the extracted attributes may include a source of a DNS query, a domain name for which the query was made, a status of the query (successful or otherwise), and time-stamp.

Following attribute extraction, processes for deriving specific features of interest (203) from the extracted attributes may be performed. These processes may include deriving a subnet from an IP address, deriving an hour of the day from a timestamp, etc.

In the exemplary case of FIG. 2, the derivation processes 203 are followed by data aggregation processes (204). Aggregation refers to combining multiple data items into a single data record and filtering refers to eliminating data records that are deemed to be not of interest for further analysis. The data aggregation processes (204) may include collecting and summarizing multiple items in the data stream together in an aggregate manner.

The data aggregation may be performed over the entire data stream or after partitioning the data stream across multiple groups of interest. For example, in the case of malware detection the derived aggregates may include a number of queries made by each host in the network over a time window, a number of successful queries, a number of unsuccessful queries, and a number of distinct queries that are successful and unsuccessful respectively.

The data aggregation processes (204) may be followed by a statistical model building process (205). For example, the statistical model building processes (205) may include building a histogram of users according to the number of distinct domains they visit within some time period, e.g., an hour. It is to be understood that various other statistical models may be used. For example, a statistical model corresponding to visited subnets, content analysis, etc.

The statistical model building process (205) may be followed by a process for the detection of statistical surprises or anomalies (206). The detection process (206) may include extracting the user(s) whose query count exceeds the mean value by a significant extent (e.g., by more than three standard deviations). It is to be understood that various other detection processes may be implemented and that the present disclosure is not limited to the examples described herein.

In one example of a statistical model, the entropy of the protocols and ports of a host may be periodically determined. In this example, a corresponding detection process may detect a change in the entropy (e.g., above a threshold) based on the past 300 values. In another example, a statistical model may measure the wavelet coefficients of a one minute histogram of intrusion detection system alerts that have fired for each host, and detection process may pick, at various points in time, those hosts that have abnormally high energy in the wavelet coefficients (e.g., either high frequency ones or the low frequency ones). In yet another example, a statistical model may determine k-means clustering of a histogram over a time interval, and a detection process may pick out the outliers. As noted above, various other models and processes are contemplated, and the specific examples provided herein are not intended to be limiting. The data source may include DNS queries from the network. Other data sources may include intrusion detection systems (IDS)/intrusion prevention systems (IPS) alerts, firewall alerts and/or logs, DNS responses, netflow records created by the router within the network, and raw network traffic and/or traces, as well as other data sources such as security updates (e.g., software patches and vulnerability discovered and published in the public domain). The analytic flow pattern may encode all these possibilities, while a specific analytic flow (100) crystallizes the data source and other atomic operators in the flow.

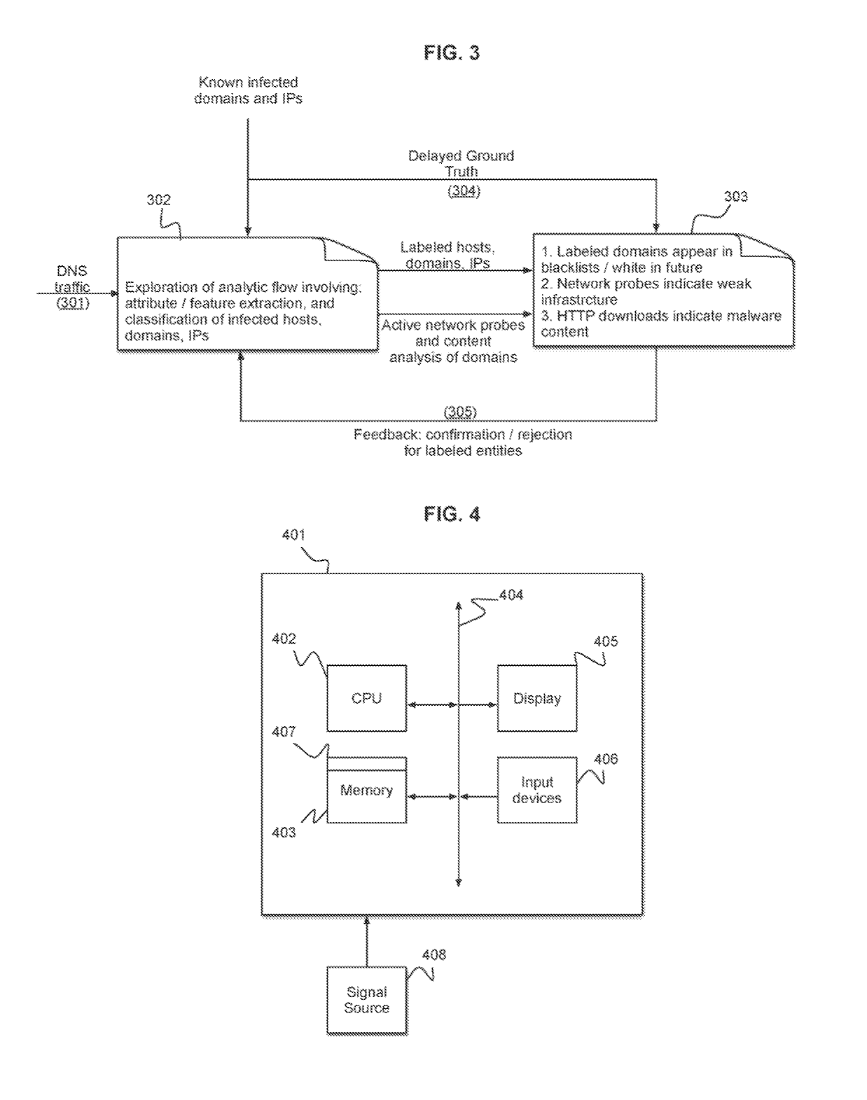

FIG. 3 illustrates a method for an end-to-end application performing a machine-learning task. Referring to FIG. 3, DNS network traffic may be ingested from the network (301).

At block (302) the method selects various analytic flows. These analytic flows may involve attribute selection, feature extraction, and classification of hosts as infected or not infected. At block (302) the method may include building a classifier and using the classifier to classify hosts.

Block (302) may be implemented as an instance of automated feedback. While the set of analytic flows label hosts based on what they determine to be the criteria for infected behavior, at block (303) the method may derive feedback based on a ground truth (304) from an external source. For example, at block (303) the method may include the determination of which of the domains visited by the hosts in the network are part of blacklisted domains in the Internet as part of content analysis. The method may include the detection of weak infrastructure given network probe data, for example, detecting bottlenecks in the infrastructure. The method may further include the detection of malware content in network traffic.

The feedback of block (303) may be used by block (302) to refine the set of analytic flows. More particularly, at block (302) the method may determine which flows predicted the infected hosts correctly in accordance with the feedback (305) and provide those flows with a higher weight. These flows are more likely to be retained. Similarly, at block (302) the method may determine which flows did not match well with the feedback, and these flows may be discarded and/or replaced by other flows, e.g., newer flows. In the manner described, an overall rate of detection may be increased. The task of deciding which flows to retain and which flows to discard may be automatically performed by a machine-learning algorithm.

The feedback may provided by one or more external sources or learning from a plurality of subscriptions from the system to one or more external sources. The feedback may confirm or reject a performance of at least one analytic flow. For example, the feedback may confirm that a domain was correctly labeled.

While one goal of the exploration shown in FIG. 3 is classification, inventive concepts embodied herein can be used for other tasks such as anomaly detection, constructing statistical models of host behaviors, and clustering.

The methodologies of embodiments of the disclosure may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

For example, FIG. 4 is a block diagram depicting an exemplary computer system for performing a method for automated data exploration. The computer system 401 may include a processor 402, memory 403 coupled to the processor (e.g., via a bus 404 or alternative connection means), as well as input/output (I/O) circuitry 405-406 operative to interface with the processor 402. The processor 402 may be configured to perform one or more methodologies described in the present disclosure, illustrative embodiments of which are shown in the above figures and described herein. Embodiments of the present disclosure can be implemented as a routine 407 that is stored in memory 403 and executed by the processor 402 to process the signal from the signal source 408. As such, the computer system 401 is a general-purpose computer system that becomes a specific purpose computer system when executing the routine 407 of the present disclosure.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to a multi-core processor that contains multiple processing cores in a processor or more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the disclosure is not limited to those precise embodiments, and that various other changes and modifications may be made therein by one skilled in the art without departing from the scope of the appended claims.

What is claimed is:

1. A method for automated data exploration comprising:
receiving a data flow via a network of connected computer nodes;
extracting a plurality of attributes of the data flow;
deriving a plurality of features from each of the attributes;
aggregating a plurality of data items of the data flow;
creating a model of the data flow given the attributes, the features, and an aggregation of the data items; and
detecting an event in the data flow according to the model.

2. The method of claim 1, wherein the aggregation is performed over an entirety of the data flow.

3. The method of claim 1, further comprising partitioning the data flow, wherein the aggregation is performed over a partition of the data flow.

4. The method of claim 1, wherein the event inconsistent with the model.

5. The method of claim 4, further comprising receiving feedback corresponding to a measured performance of the model.

6. The method of claim 5, further comprising adjusting the extraction of the plurality of attributes of the data flow according to the feedback.

7. A computer program product for automated data exploration comprising:
a computer readable storage medium having computer readable program code embodied therewith, the computer readable program code comprising:
computer readable program code configured to select a plurality of analytic flows from an analytic flow pattern;
computer readable program code configured to execute a task, wherein the task is tracked by the plurality of analytic flows;
computer readable program code configured to receive feedback for each of the plurality of analytic flows;
computer readable program code configured to determine a performance score for each of the plurality of analytic flows; and
computer readable program code configured to adjust the selecting of the plurality of analytic flows from the analytic flow pattern according to the performance score.

8. The computer program product of claim 7, wherein adjusting the flow comprises adding a flow from the pattern.

9. The computer program product of claim 7, wherein adjusting the selection of the plurality of analytics flows comprises removing a flow from an existing selection.

10. The computer program product of claim 7, further comprises requesting the feedback.

11. The computer program product of claim 10, wherein the feedback is provided by an external source.

12. The computer program product of claim 10, wherein the feedback is provided learned from a plurality of subscriptions to an external source.

13. A method for automated data exploration comprising:
selecting a plurality of analytic flows from an analytic flow pattern for detecting an anomaly in computer network traffic between a network of connected computer nodes;
executing a task for detecting the anomaly in the computer network traffic, wherein the task is tracked by the plurality of analytic flows;
receiving feedback for each of the plurality of analytic flows;
determining a performance score for each of the plurality of analytic flows indicative of a respective analytic flow's ability to detect malware activity in the computer network traffic; and
adjusting the selection of the plurality of analytic flows according to the performance score.

14. The method of claim 13, wherein adjusting the selection of the plurality of analytic flows comprises adding an analytic flow from the pattern.

15. The method of claim 13, wherein the selection of the plurality of analytic flows comprises removing an analytic flow from the existing selection.

16. The method of claim 13, wherein further comprises requesting the feedback.

17. The method of claim 13, wherein the feedback is provided by an external source.

18. The method of claim 13, wherein the feedback is provided learned from a plurality of subscriptions to an external source.

19. The method of claim 13, wherein the feedback is a confirmation of a performance of at least one analytic flow.

20. The method of claim 13, wherein the feedback is a rejection of a performance of at least one analytic flow.
